(19) United States
(12) Patent Application Publication
(10) Pub. No.: US 2025/0371966 A1
(43) Pub. Date: Dec. 4, 2025

(54) SYSTEM AND METHOD FOR RESPONDING TO AN EMERGENCY INCIDENT IN A FACILITY

(71) Applicant: Dustin Louis Folkes, Highlands Ranch, CO (US)

(72) Inventor: Dustin Louis Folkes, Highlands Ranch, CO (US)

(21) Appl. No.: 18/731,222

(22) Filed: May 31, 2024

(51) Int. Cl. G08B 25/00; G08B 7/06; H04M 11/04

(52) U.S. Cl. CPC G08B 25/006; G08B 7/066; H04M 11/04

(57) ABSTRACT

A system for responding to an emergency incident in a facility is described. The system includes a display device with a virtual map of the facility and a plurality of devices configured to be respectively worn by a plurality of users in the facility. Each device of the plurality of devices is configured to be activated upon detection of the emergency incident in the facility. When activated, each device of the plurality of devices is configured to provide a non-audible alert to other devices of the plurality of devices, provide an emergency indication along with its location data for display on the virtual map, and place a one-way audio call through a cellular network to at least one recipient.

### TECHNICAL FIELD

The present disclosure relates to a system and method for responding to an emergency incident, for example, the presence of an assaultive intruder, in a facility.

### BACKGROUND

Deaths and injuries associated with shootings on campuses or facilities, such as high schools and colleges, are an ever growing problem, particularly in the United States. Delays are often encountered between witnessing an active shooter (or an associated crime) and calling law enforcement personnel, for example by dialing 911. Such delays can potentially result in an increase in casualties until the shooter can be apprehended and/or neutralized. The lack of widespread and effective communication within campuses often significantly contributes to these delays. Also, personnel at the campuses or facilities often have limited knowledge of the intrusion of an active shooter until they are close enough to hear or see an actual shooting happen. Moreover, such personnel may possess limited know-how on how best to bring such a situation under control.

### SUMMARY OF THE INVENTION

In an aspect, the present disclosure relates to a system for responding to an emergency incident in a facility. The system includes a display device with a virtual map of the facility and a plurality of devices configured to be respectively worn by a plurality of users in the facility. Each device is configured to be activated upon detection of the emergency incident in the facility. When activated, each device is configured to provide a non-audible alert to other devices, provide an emergency indication along with its location data for display on the virtual map, and place a one-way audio call through a cellular network to at least one recipient.

In another aspect, the present disclosure relates to a system for communicating and tracking real-time whereabouts of a movable subject in a facility. The system includes a plurality of devices configured to be respectively worn by a plurality of users in the facility. Each device includes a microphone, an input unit and an output unit, and a transceiver selectively configured to transmit an instruction to other devices upon an activation of the input unit and receive the instruction from any of the other devices upon an activation of the input unit on any of the other devices. The system further includes a control system. In response to a transmission of the instruction by the transceiver associated with any device or a receipt of the instruction by the transceiver associated with any device, the control system is configured to activate a non-audible alert on the output unit and detect a last device on which the input unit is last activated or from which the instruction is last transmitted. The control system is further configured to alter at least one attribute of a marker corresponding to the last device on a virtual map of the facility. Further, the control system is configured to place a call through a cellular network to at least one recipient, such that when the call is established, an audible output inputted into the microphone associated with the last device, is received by the recipient.

In yet another aspect, the present disclosure relates to a method for responding to an emergency incident in a facility. The method includes activating a device of a plurality of devices upon detection of the emergency incident in the facility. The plurality of devices are configured to be respectively worn by a plurality of users in the facility. The method further includes providing, by the device, a non-audible alert to other devices and providing, by the device, an emergency indication along with its location data for display on a virtual map of the facility displayed on a display device. Further, the method includes placing, by the device, a one-way audio call through a cellular network to at least one recipient.

### BRIEF DESCRIPTION

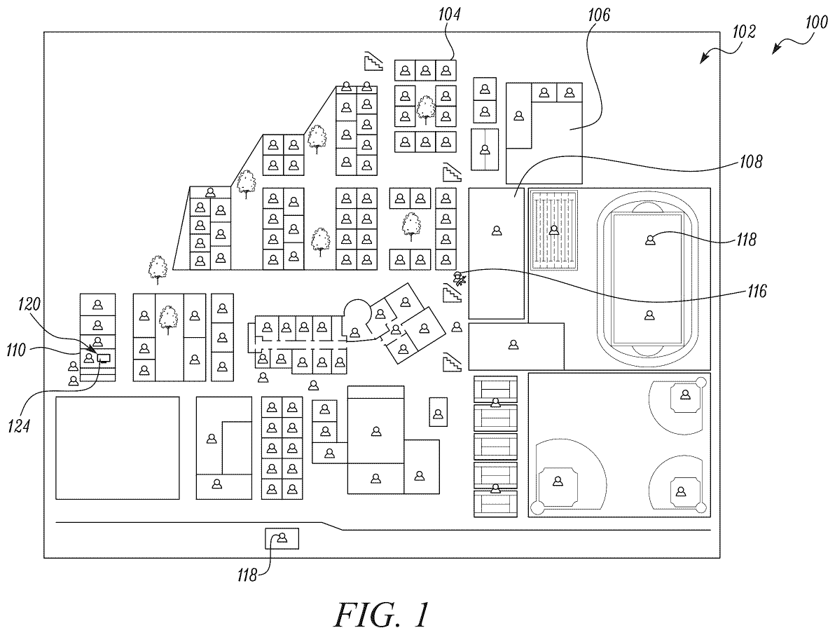

FIG. 1 illustrates a facility having a system for responding to an emergency incident in the facility, in accordance with one or more aspects of the present disclosure;

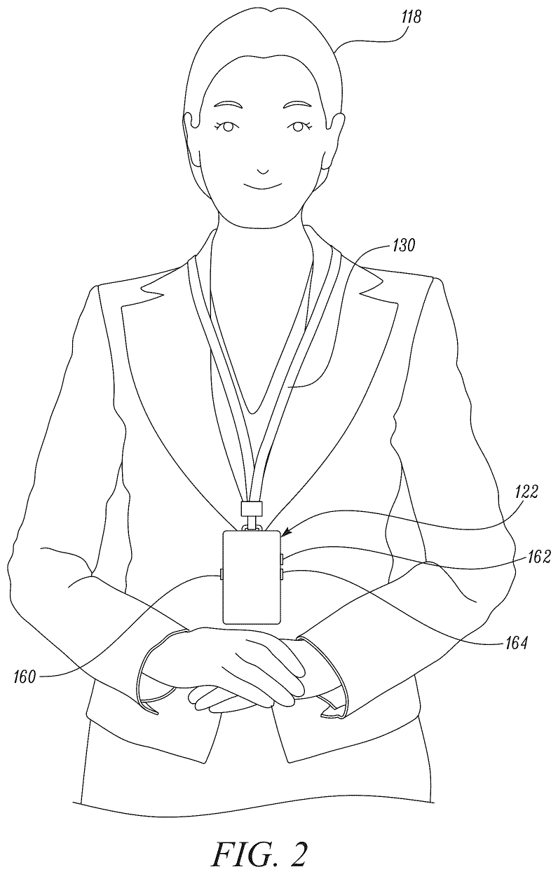

FIG. 2 depicts a device worn by a user for responding to the emergency incident in the facility of FIG. 1, in accordance with one or more aspects of the present disclosure;

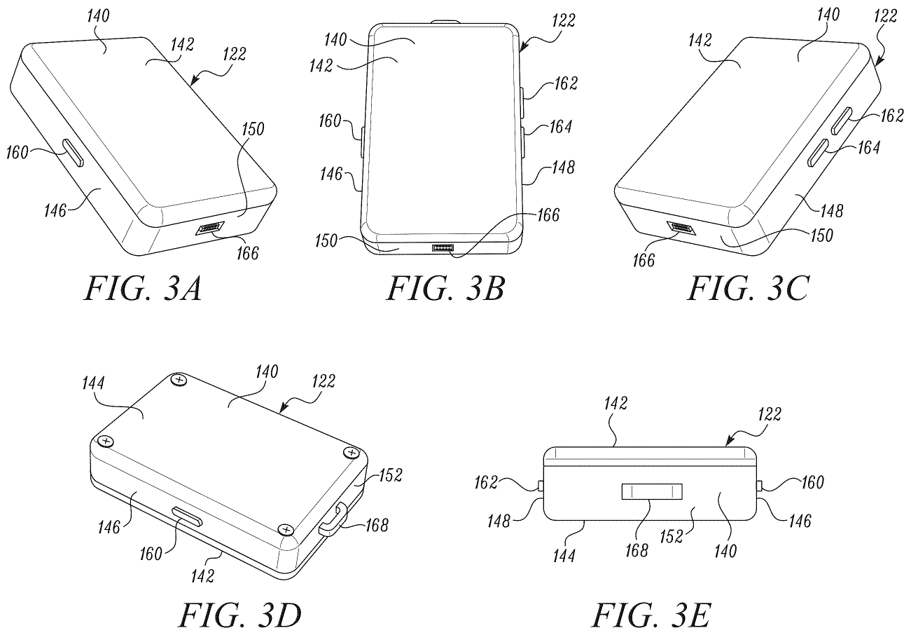

FIGS. 3A through 3E illustrate various views of the device of FIG. 2, in accordance with one or more aspects of the present disclosure;

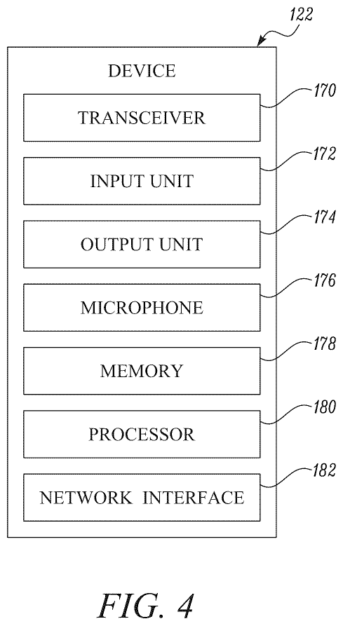

FIG. 4 is a block diagram illustrating various parts of the device of FIGS. 2 and 3A through 3E, in accordance with one or more aspects of the present disclosure;

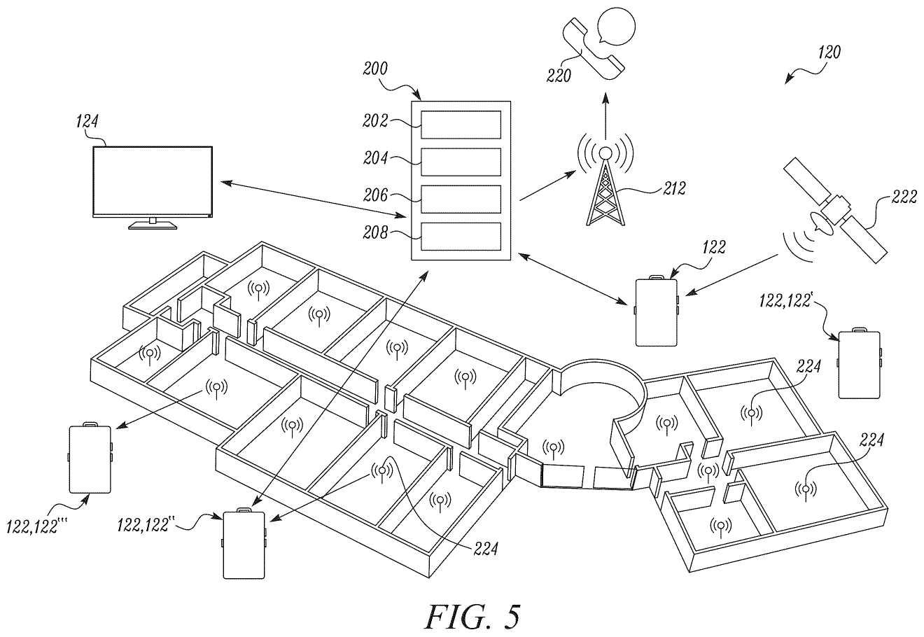

FIG. 5 is a schematic view of the system for responding to the emergency incident in the facility of FIG. 1, in accordance with one or more aspects of the present disclosure;

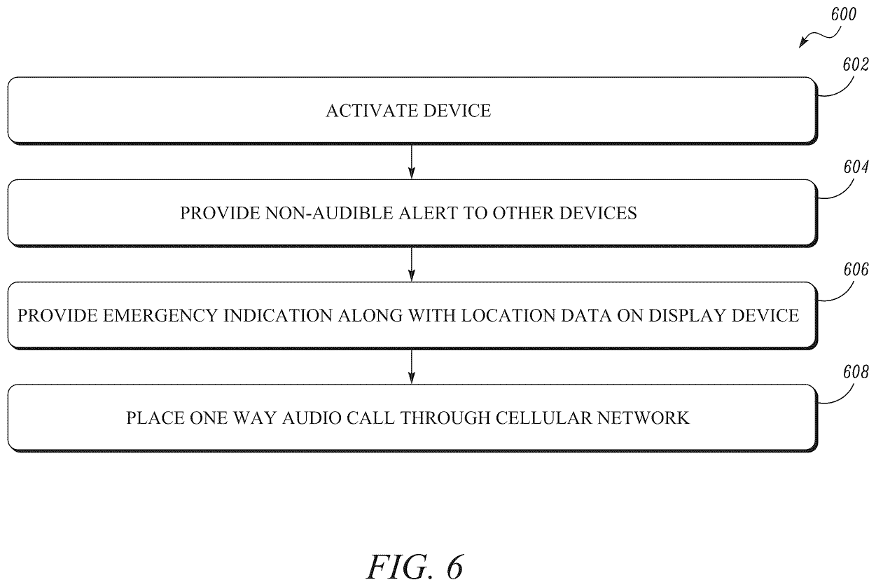

FIG. 6 illustrates an exemplary method for responding to the emergency incident in the facility of FIG. 1, in accordance with one or more aspects of the present disclosure; and

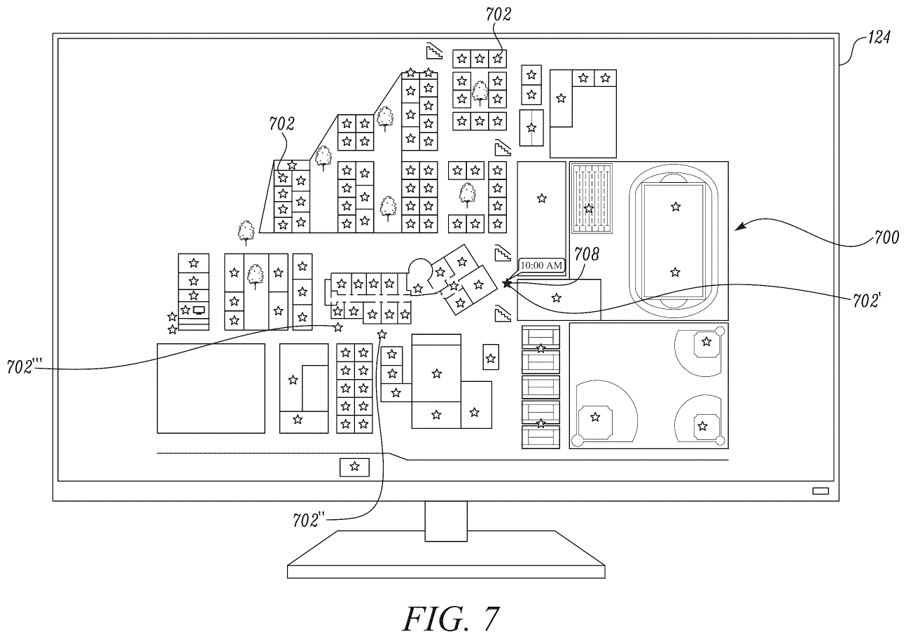

FIGS. 7 through 9 illustrate real-time tracking of whereabouts of a movable subject associated with the emergency incident on a display device, in accordance with one or more aspects of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIG. 1, a facility 100 is shown. The facility 100 may be set at any physical location and may include a building or a group of buildings or similar structures and/or a compound where activities such as education, shopping, working, etc., may be performed, and where people, e.g., children or adults, may gather in mass numbers for the performance of those activities. For example, the facility 100 may be an educational institution such as a school 102. The school 102 may include multiple areas such as, but not limited to, one or more classrooms 104 to accommodate students and teachers, one or more parking areas 106, one or more outdoor courts 108, one or more administrative offices 110, and so on. Further, the school 102 may include several staff members 118, such as teachers, attendants, coaches, administrative assistants, and a principal. For the purposes of imparting education to the students, the staff members 118 may be spread throughout the school 102 and the location of the staff members 118 may keep changing over time. For example, the teachers may primarily be in the classrooms 104, the attendants in the parking areas 106, the coaches in the outdoor courts 108, and the administrative assistants in the administrative offices 110. Although FIG. 1 depicts the facility 100 as a school 102, it would be appreciated that aspects of the present disclosure may be suitably applied to any other facility such as an office, a factory, a medical center, a stadium, or the like. Therefore, reference to the school 102 and any personnel (staff member, etc.) at the school 102 for discussing aspects of the present disclosure may be exemplary.

In accordance with various embodiments, the facility 100 includes a system 120 (also shown in FIG. 5) for responding to an emergency incident in the facility 100. The emergency incident may correspond to any unexpected or unplanned event that poses a threat of injury or death to individuals in the facility 100. For example, the emergency incident can be an active shooter 116 or an assaultive intruder 116 (interchangeably referred to as a ‘movable subject 116’) posing a security threat to the individuals in the facility 100 and/or can be a medical emergency like an injury. The system 120 facilitates tracking of such emergency incidents in real time in the facility 100 and helps to communicate data related to such tracking to one or more recipients.

With continued reference to FIG. 1, the system 120 includes a plurality of devices 122 (shown in FIGS. 2, 3A through 3E, and 5) and a display device 124. In accordance with various embodiments, the devices 122 are configured to be respectively worn by the users (for example, the staff members 118), e.g., during day-to-day operations in the facility 100. As an example, FIG. 2 depicts a user such as a staff member 118, wearing the device 122, e.g., around her neck using a lanyard 130 connected to the device 122. Each device 122 may be activated by its respective user, e.g., upon the user detecting (e.g., witnessing or sensing) the emergency incident in the facility 100. Various components and functioning of the devices 122 will be described in detail in the forthcoming description.

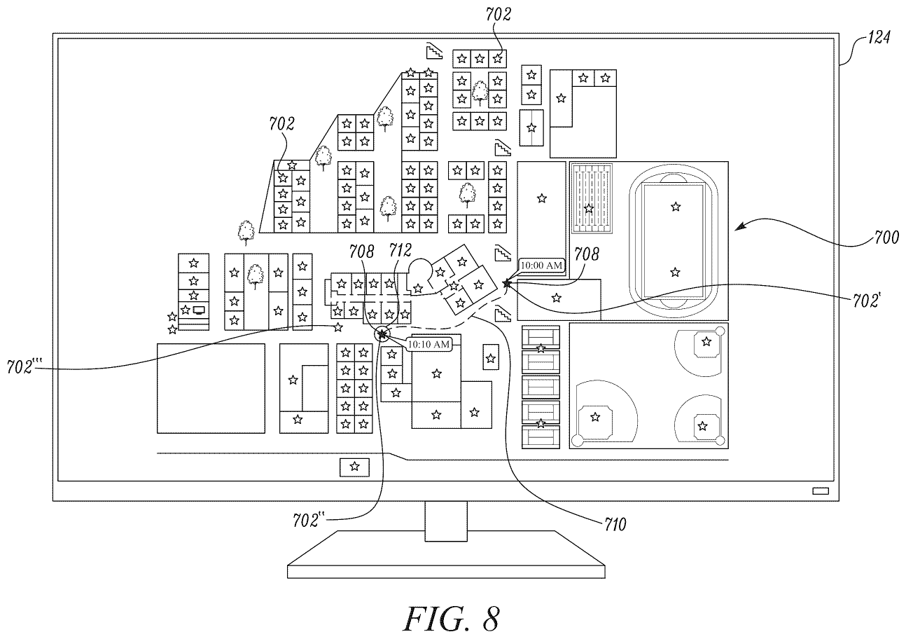

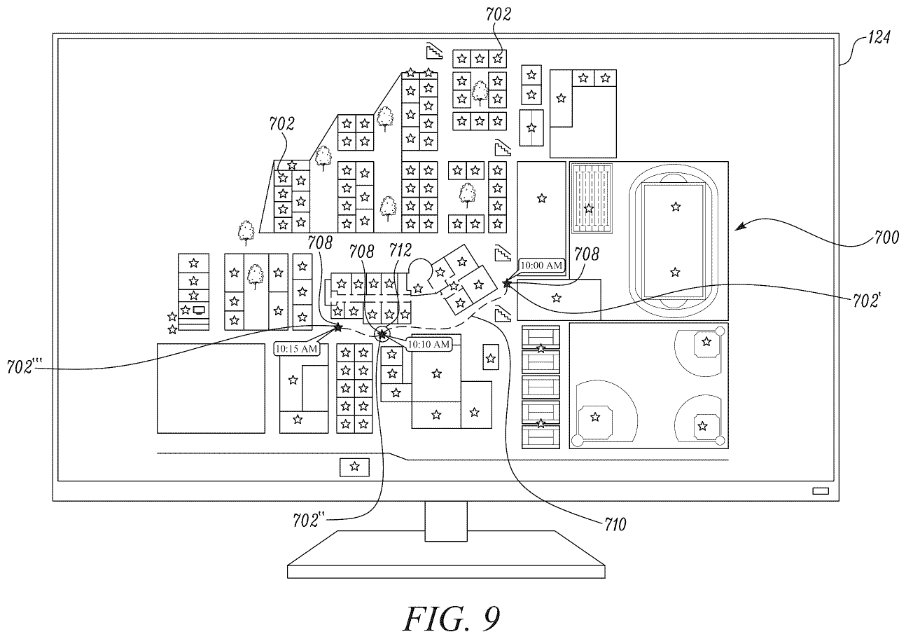

The display device 124 is configured to display data received from other communication devices, for example, the plurality of devices 122 and/or a control system 200 (shown in FIG. 5). The display device 124 may include one or more of a display screen, a projector, a monitor or any other visual output device now known or in the future developed. The display device 124 may be positioned within and/or outside the facility 100. For example, as shown in FIG. 1, the display device 124 may be positioned in one of the administrative offices 110 of the facility 100. Although FIG. 1 shows only one display device 124, it would be appreciated that there can be more than one display device 124 within and/or outside the facility 100, and which may combinedly or in concert be able to perform the functions as are discussed for the display device 124. In accordance with some embodiments, the display device 124 is configured to display data, images, or information to a user, e.g., a personnel in relative proximity and having ready access to the display device 124. For example, as shown in FIGS. 7 through 9, the display device 124 may display a virtual map 700 of the facility 100 and indicate locations of the devices 122 respectively through markers 702 on the virtual map 700 of the facility 100. In some embodiments, as shown in FIGS. 8 and 9, the display device 124 is also configured to display a path 710 on the virtual map 700 to display real-time whereabouts of the movable subject 116 (shown in FIG. 1) associated with the emergency incident in the facility 100.

Referring to FIGS. 3A through 3E, each device 122 includes a housing 140. The housing 140 may include a front portion 142 and a back portion 144 opposite to the front portion 142. The housing 140 may be made of any durable material, such as plastic, silicone, or various other materials known in the art or developed in the future. The housing 140 further has four (4) sidewalls, for example, a first sidewall 146, a second sidewall 148, a third sidewall 150, and fourth sidewall 152. In some embodiments, the entire housing 140, including the front portion 142, back portion 144, and sidewalls 146, 148, 150, and 152, may be made of a clear or translucent material. The housing 140 may be made out of a range of materials such as polyethylene, PVC (Polyvinyl Chloride), and hard silicone, but it should be understood that a wide range of suitable materials may be used. In accordance with various embodiments, the device 122 includes buttons (see buttons 160, 162, 164) for activating the device 122, e.g., upon detection of the emergency incident in the facility 100. For example, a first button 160 may be positioned on the first sidewall 146 and a second button 162 may be positioned on the second sidewall 148 of the device 122. In some embodiments, a third button 164 may also be positioned on the second sidewall 148 of the device 122. A charging port 166 for charging the device 122 is provided on the third sidewall 150, and a loop 168 for attaching the device 122 to the lanyard 130 is provided on the fourth sidewall 152. It will be appreciated that the device 122 shown in FIGS. 3A through 3E is an exemplary device and any variation in the structure of the device 122 falls within the scope of the present disclosure.

In accordance with various embodiments, a plurality of electrical and electronic components, providing power, operational control, communication, and the like, are provided within the housing 140 of each device 122. The various components provided in the housing 140 of each device 122 will be described hereinafter with reference to FIG. 4. It should be appreciated by those of ordinary skill in the art that FIG. 4 depicts the device 122 in a simplified manner and a practical embodiment may include additional components and suitably configured logic to support known or conventional operating features that are not described in detail herein. It will further be appreciated by those of ordinary skill in the art that the device 122 can include any communication device, such as a smartphone, or one or more of the features of the device 122 may be incorporated into any such communication device.

The description below describes the components of only one device 122, however such description will be suitably applicable for all the other devices 122 of the system 120, as well. The device 122 includes, among other components, a transceiver 170, an input unit 172, an output unit 174, a microphone 176, a memory 178, a processor 180, and a network interface 182. The components of the device 122, including the transceiver 170, the input unit 172, the output unit 174, the microphone 176, the memory 178, the processor 180, and the network interface 182 cooperate with each other to enable operations of the device 122. Each component may communicate with each other via a local interface (not shown). The local interface may be, for example, but not limited to, one or more buses or other wired or wireless connections, as is known in the art. The local interface may have additional elements, which are omitted for simplicity, such as controllers, buffers (caches), drivers, repeaters, and receivers, among many others, to enable communications. Further, the local interface may include address, control, and/or data connections to enable appropriate communications among the aforementioned components.

As illustrated, the device 122 in the exemplary embodiment includes the transceiver 170 to transmit signals to and receive signals from the other communication devices, such as other devices 122 and/or the control system 200 (shown in FIG. 5). For example, the transceiver 170 of each device 122 is selectively configured to transmit an instruction to the other devices 122 of the plurality of devices 122 upon an activation of its input unit 172 and receive the instruction from any of the other devices 122 upon an activation of the input unit 172 of any of the other devices 122. In some embodiments, the transceiver 170 is configured to transmit the instruction to the other devices 122 and receive the instruction from any of the other devices 122 via the control system 200. The transceiver 170 is further configured to transmit an audible output inputted into the microphone 176 to at least one recipient of a communication device over a cellular network 212. The transceiver 170 includes a transmitter circuitry and a receiver circuitry to enable the device 122 to communicate with the other communication devices. The transmitter circuitry includes any appropriate circuitry to provide the instructions and/or the audible output to the other communication devices. Similarly, the receiver circuitry includes appropriate circuitry to receive the instructions from the other communication devices. It will be appreciated by those of ordinary skill in the art that the device 122 may include a single transceiver 170 as shown, or alternatively separate transmitting and receiving components, for example but not limited to, a transmitter, a transmitting antenna, a receiver, and a receiving antenna.

The input unit 172 is configured to receive user input from its user (i.e., the staff member 118). User input may be provided via, for example, the first button 160, the second button 162, and/or the third button 164 or any other user input mechanism now known or developed in the future, upon detection of the emergency incident in the facility 100. The output unit 174 is configured to provide output, such as a non-audible alert, to its user in response to the activation of the input unit 172 of its device 122 or any other device 122. The output unit 174 may include the front portion 142, a piezoelectric element (not shown) and a light emitting diode (LED) element (not shown). The output may be provided to the user using the piezoelectric element that causes the device 122 to vibrate and/or the LED element positioned underneath the front portion 142 that causes the front portion 142 of the device 122 to illuminate. In other embodiments, an LED element may be positioned adjacent the bottom portion 144 so that the bottom portion 144 will also illuminate. Because the sidewalls 146, 148, 150, 152 may also be made of translucent material, the sidewalls 146, 148, 150, 152 may also illuminate when the LED elements are illuminated. It would be appreciated that although the piezoelectric element and the LED element(s) are described as providing the non-audible alert, such non-audible alerts can be provided using any other elements known in the art.

The microphone 176 is configured to obtain the audible output provided by its user upon activation of the input unit 172. For example, the audible output may correspond to sound waves generated by the user. The microphone 176 is configured to convert the sound waves into electrical signals that are transmitted, via the transceiver 170 to the recipient.

The network interface 182 allows the device 122 to connect on various networks, including cellular networks 212 with one or more towers. The network may also be a wireless access network (WAN), a radio frequency (RF) network, or both. The network interface 182 may include, for example, an Ethernet card or adapter or a wireless local area network (WLAN) card or adapter. Additionally, or alternatively, the network interface 182 includes a radio frequency interface for wide area communications, such as Long-Term Evolution (LTE) networks, or any other network now known or in the future developed. In an embodiment, the network interface 182 includes address, control, and/or data connections to enable appropriate communications on the network.

The memory 178 is a non-transitory memory configured to store a set of instructions that are executable by the processor 180 to perform predetermined operations. For example, the memory 178 may include any of the volatile memory elements (for example, random access memory (RAM)), nonvolatile memory elements (for example, read only memory (ROM)), and combinations thereof. Moreover, the memory 178 may incorporate electronic, magnetic, optical, and/or other types of storage media.

The processor 180 is configured to execute the instructions stored in the memory 178 to perform the predetermined operations, for example the detailed functions of the device 122 as will be described later with respect to FIGS. 6 through 9. The processor 180 may include one or more microprocessors, microcontrollers, DSPs (digital signal processors), state machines, logic circuitry, or any other device or devices that process information or signals based on operational or programming instructions. The processor 180 may be implemented using one or more controller technologies, such as Application Specific Integrated Circuit (ASIC), Reduced Instruction Set Computing (RISC) technology, Complex Instruction Set Computing (CISC) technology or any other similar technology now known or in the future developed. The processor 180 is configured to cooperate with other components of the device 122 to perform operations pursuant to the activation of the input unit 172 of its device 122 and the receipt of the instruction by the transceiver 170 from any device 122 of the plurality of devices 122.

FIG. 5 depicts the system 120 for responding to the emergency incident in the facility 100 by communicating and tracking real-time whereabouts of the movable subject 116 (shown in FIG. 1) in the facility 100. The system 120 includes the control system 200, the devices 122, and the display device 124. The communication between the control system 200, the plurality of devices 122, and the display device 124 occurs through a network including, but not limited to, a direct network, a wide area network (WAN) (for example, a transport control protocol/internet protocol (TCP/IP) based network), a cellular network, and a local area network (LAN) employing any of a variety of communications protocols as is well known in the art or developed in the future.

The control system 200 is configured to perform one or more operations in response to the transmission of the instruction by the transceiver 170 associated with any device 122 of the plurality of devices 122 or the receipt of the instruction by the transceiver 170 associated with any device 122 of the plurality of devices 122. The components and the functionality of the control system 200 are described in detail hereinafter. The control system 200 is electrically and/or communicatively coupled to the devices 122 and the display device 124. In some embodiments, the control system 200 may include the display device 124. The control system 200 includes electrical and electronic components, for example, for providing power, operational control, and communication within the control system 200. In some embodiments, the control system 200 includes, among other things, a control system transceiver 202, a control system network interface 204, a control system memory 206, and a control system processor 208.

It should be appreciated by those of ordinary skill in the art that FIG. 5 depicts the control system 200 in a simplified manner and a practical embodiment may include additional components and various suitably configured logic to support known or conventional operating features that are not described in detail herein. It will further be appreciated by those of ordinary skill in the art that the control system 200 may include one or more of a personal computer, a desktop computer, a tablet, a smartphone, a wearable device, or any other server now known or in the future developed. It will further be appreciated by those of ordinary skill in the art that the control system 200 may alternatively function within or as part of a remote server, a cloud server, or any other remote computing mechanism now known or in the future developed. Although the description below discusses the functions and operations performed by the control system 200, a person skilled in the art would appreciate that, in some embodiments, the functions and operations of the control system 200 can be performed in a single device or in a distributed manner by two or more devices without limiting the scope of the claimed subject matter.

The components of the control system 200 (for example 202, 204, 206, 208) are communicatively coupled via a control system local interface (not shown). The control system local interface may include, among other things, one or more buses or other wired or wireless connections, as is now known in the art or in the future developed. In an embodiment, the control system local interface has additional elements, which are omitted for simplicity, such as controllers, buffers (caches), drivers, repeaters, and receivers, among many others, to enable communications. Further, in some embodiments, the control system local interface includes address, control, and/or data connections to enable appropriate communications among the aforementioned components.

The control system 200 in the illustrated example includes the control system transceiver 202. The control system transceiver 202, incorporating a control system transceiver antenna (not shown), enables wireless communication between the devices 122, the display device 124, and various other communication devices. It will be appreciated by those of ordinary skill in the art that the control system 200 includes a single control system transceiver 202 as shown, or alternatively separate transmitting and receiving components, for example, but not limited to, a transmitter, a transmitting antenna, a receiver, and a receiving antenna and/or any combination thereof.

The control system network interface 204 is used to enable the control system 200 to communicate on various networks, including cellular networks 212 with one or more towers. The networks may include a wireless access network (WAN), a radio frequency (RF) network, or both. The control system network interface 204 may include, for example, an Ethernet card or adapter or a wireless local area network (WLAN) card or adapter. Additionally, or alternatively, the control system network interface 204 includes a radio frequency interface for wide area communications, such as Long-Term Evolution (LTE) networks, or any other network now known or in the future developed. In an embodiment, the control system network interface 204 includes address, control, and/or data connections to enable appropriate communications on the network.

The control system memory 206 includes any non-transitory memory elements comprising one or more of volatile memory elements (for example, a random access memory (RAM), nonvolatile memory elements (for example, read-only memory “ROM”), and combinations thereof). Moreover, the control system memory 206 incorporates electronic, magnetic, optical, and/or other types of storage media now known or in the future developed. Note that, in some embodiments, the control system memory 206 has a distributed architecture, where various components are situated remotely from each other, but are accessed by the control system processor 208. The software in the control system memory 206 includes one or more software programs, each of which includes an ordered listing of executable instructions for implementing logical functions.

The control system processor 208 is configured to execute the instructions stored in the control system memory 206 to perform the predetermined operations, for example, the detailed functions of the control system 200 as will be described later with respect to FIGS. 6 through 9. The control system processor 208 may include one or more microprocessors, microcontrollers, DSPs (digital signal processors), state machines, logic circuitry, or any other device or devices that process information or signals based on operational or programming instructions. The control system processor 208 may be implemented using one or more controller technologies, such as Application Specific Integrated Circuit (ASIC), Reduced Instruction Set Computing (RISC) technology, Complex Instruction Set Computing (CISC) technology or any other similar technology now known or in the future developed. The control system processor 208 is configured to cooperate with other components of the control system 200 to perform operations in response to the transmission of the instruction by the transceiver 170 associated with any device 122 of the plurality of devices 122 or the receipt of the instruction by the transceiver 170 associated with any device 122 of the plurality of devices 122.

The description below discusses the functions and operations performed by the respective control system 200, the devices 122, and the display device 124 with reference to FIGS. 5 through 9. Although the description below discusses the functions and operations performed by the respective control system 200, the devices 122, and the display device 124, a person skilled in the art would appreciate that, in some embodiments, the functions and operations of the control system 200, the plurality of devices 122, and the display device 124 are performed in a single device or in a distributed manner by two or more devices without limiting the scope of the claimed subject matter.

FIG. 6 depicts a flow diagram of a method 600 for responding to the emergency incident in the facility 100. The method 600 begins when, for example, a staff member 118 detects an emergency incident, witnesses (sees and/or hears and/or senses in some way) the movable subject 116 (shown in FIG. 1) in the facility 100, and activates their device 122 (hereinafter interchangeably referred to as a first device 122′ shown in FIG. 5) upon detection of the emergency incident at 602. In accordance with various embodiments, the first device 122 is activated upon activation of the input unit 172 of the first device 122′, for example, by simultaneously pressing the first button 160 and the second button 162 of the input unit 172 of the first device 122.

Upon activation of the first device 122″, the processor 180 of the first device 122′ transmits an instruction to other devices 122 (i.e., the remaining devices 122) via the transceiver 170. The first device 122′ is configured to transmit the instruction to the other devices 122 directly or via the control system 200.

At 604, the first device 122′ provides a non-audible alert to other devices 122. In accordance with various embodiments, the respective processors 180 of the other devices 122, upon receiving the instruction (via the respective transceivers 170) activate the non-audible alert on the respective output units 174. The non-audible alert corresponds to a vibration in a first predefined vibration pattern and/or an illumination in a first predefined illumination color of the devices 122. In some embodiments, the non-audible alert on the output units 174 of the other devices 122 is activated directly based on the instruction received from the first device 122′. In some other embodiments, the control system 200, in response to the transmission of the instruction by the transceiver 170 associated with the first device 122′ or the receipt of the instruction by the transceiver 170 associated with any device 122, instructs the respective processors 180 of the other devices 122 to activate the non-audible alert on the output units 174. Additionally, in some embodiments, the processor 180 of the first device 122′ also activates its output unit 174 to provide the non-audible alert upon activation of the first device 122.

At 606, the first device 122 provides an emergency indication 708 (shown in FIGS. 7 through 9) along with its location data on the display device 124, e.g., on the virtual map 700. The emergency indication 708 corresponds to alteration of at least one attribute of the marker 702″ corresponding to the first device 122. The alteration of the at least one attribute of the marker 702 corresponds to altering color, boundary, pattern, or any characteristic of the corresponding marker 702′ on the virtual map 700. For example, the emergency indication may correspond to altering the color of the marker 702′ of the first device 122′ to a first marker color. In accordance with various embodiments, the processor 180 of the first device 122′ directly controls the display device 124 to display the emergency indication 708 on the virtual map 700 of the facility 100. In some other embodiments, the control system 200, in response to the transmission of the instruction by the transceiver 170 associated with the first device 122′ or the receipt of the instruction by the transceiver 170 associated with any device 122, controls the display device 124 to provide the emergency indication 708.

In accordance with various embodiments, the location data of the first device 122′ is also provided along with the emergency indication 708 on the virtual map 700. For example, as shown in FIGS. 7 through 9, the location data may be provided by displaying the emergency indication 708 on the virtual map 700 at a location corresponding to the location data on the virtual map 700. To this end, the first device 122′ is configured to determine its location data based on signals received from one or more beacons 224 installed in the facility 100. The first device 122′ is configured to obtain signals transmitted by the beacons 224 and determine its location data based on the obtained signals. The location data may include the position coordinates, an area identifier (such as an outdoor court 108), a floor identifier (for example, 3^{rd} floor), a building identifier (such as a library), or any other identifier for identifying the positioning of the first device 122 with respect to the facility 100. In some embodiments, when the first device 122′ is outside the facility 100 and/or not in the range of any beacon 224, the location data of the first device 122′ may be determined using a global positioning system (GPS) 222. It would be appreciated that the determination of location data based on the signals received from the beacons 224 within the facility 100 or the GPS is well known in the art and is not described herein in detail for the sake of brevity.

At 608, the first device 122 places a one-way audio call through the cellular network 212 to at least one recipient. The one-way audio call may correspond to the uni-directional transmission of audio from a first party, for example, the staff member 118 to a second party such as a law enforcement personnel, without any transmission of audio from the second party to the first party. In accordance with various embodiments, upon activation of the input unit 172 of the first device 122, the processor 180 of the first device 122′ is configured to place, via the transceiver 170, the one-way audio call through the cellular network 212 to a communication device 220 of the at least one recipient. The processor 180 further activates the microphone 176 of the first device 122′ upon the placement of the one-way audio call to transmit audio data provided by the user of the first device 122′ to the at least one recipient. In some other embodiments, the control system 200, in response to the transmission of the instruction by the transceiver 170 associated with the first device 122′ or the receipt of the instruction by the transceiver 170 associated with any device 122, places the one-way audio call to connect the at least one recipient with the first device 122. For example, the at least one recipient may correspond to a law enforcement personnel (such as, for example, a 911 operator).

As the movable subject 116 (shown in FIG. 1) moves around in the facility 100, one or more devices 122 (for example, a second device 122″, a third device 122′″, and so on) can be activated in sequence to the first device 122′ based on the detection of the movable subject 116 (shown in FIG. 1) in the facility 100. For example, upon activation of the first device 122′, if another staff member 118 witnesses the movable subject 116 (shown in FIG. 1), for example, at a different location, the other staff member 118 also activates their device 122 (for example, the second device 122) in sequence to the first device 122′. Similarly, the third device 122′″ can be activated upon detection of the movable subject 116 (shown in FIG. 1) by yet another staff member 118, and so on.

In accordance with various embodiments, the control system 200 detects a last (i.e., most recent) device 122 on which the input unit 172 is last activated or from which the instruction is last transmitted. Upon detection of the last device 122, the control system 200 alters the attribute of the marker 702 corresponding to the last device 122 on the virtual map 700 of the facility 100. The control system 200 also places a one-way audio call through the cellular network 212 to a recipient, such that when the call is established, an audible output inputted into the microphone 176 associated with the last device 122, is received by the recipient.

When the last device 122 corresponds to the first device 122′, the control system 200 is configured to alter the attribute of the marker 702 corresponding to the first device 122′ on the virtual map 700 of the facility 100 and place the one-way audio call through the cellular network 212 to the recipient, as described above. In an exemplary embodiment, when the second device 122″ is activated in sequence to the first device 122′, the last device 122 corresponds to the second device 122″ and similarly when the third device 122′″ is activated in sequence to the second device 122″, the last device may correspond to the third device 122′″, and so on.

In an exemplary embodiment, when the second device 122″ is activated, the control system 200 is configured to provide the emergency indication 708 along with the location data of the second device 122″ on the virtual map 700. For example, as shown in FIG. 8, the emergency indication 708 corresponds to alteration of at least one attribute of a marker 702″ corresponding to the second device 122″. The alternation of the attribute of the marker 702″ corresponds to altering color and/or pattern or the like of the corresponding marker 702″ on the virtual map 700. For example, altering the attribute of the marker 702″ may correspond to altering the color of the marker 702″ to the first marker color. In some embodiments, the emergency indication 708 provided for the first device 122′ and the second device 122″ may be different from each other. For example, the emergency indication 708 provided for the first device 122 may include altering the color of the marker 702′, while the emergency indication 708 provided for the last device 122 i.e., the second device 122″ may include altering the color of the marker 702″ and flashing the boundary of the marker 702″.

Further, when the second device 122″ is activated in sequence to the first device 122′, the control system 200 is configured to place a second one-way call (i.e., an additional one-way audio call) to connect the second device 122″ with a second communication device of at least one second recipient (i.e., an additional recipient) through the cellular network 212. Such a recipient may be an additional law enforcement personnel (for example, another 911 operator). In some embodiments, the control system 200 is configured to determine a distance between the first device 122′ and the second device 122″ and proceed with placing the second one-way audio call described above when the distance between the first device 122′ and the second device 122″ is greater than a threshold value. In other words, when the distance between the first device 122′ and the second device 122″ is less than the threshold value, the control system 200 disables the placement of the second one-way audio call between the second device 122″ and the at least one second recipient. The threshold value may be pre-defined by a user of the system 120 depending upon the preference of the user.

In some alternative embodiments, instead of placing two separate one-way audio communications for the first device 122′ and the second device 122″, the control system 200 is configured to override the one-way audio call between the first device 122′ and the recipient to connect the second device 122″ with the recipient through the cellular network 212. In such cases, the control system 200 is also configured to disable the override when the first device 122′ and the second device 122″ are within a predetermined distance of each other.

In accordance with various embodiments, the control system 200 creates a path 710 on the virtual map 700 based on a sequence of alteration of the at least one attribute of the markers 702′, 702″, 702′″ corresponding to the first device 122′, the second device 122″, and the third device 122′″. The path 710 (shown in FIG. 8) determines the real-time whereabouts of the movable subject 116 (shown in FIG. 1) on the virtual map 700 of the facility 100. In some embodiments, the control system 200 is configured to identify time stamp data associated with the alteration of the at least one attribute of the markers 702′, 702″, 702′″ and then create the path 710 based on the sequence of alteration for display on the virtual map 700 of the display device 124.

In accordance with various embodiments, each device 122 can be activated based on different manner of activation. The manner of activation of the input unit 172 of the device 122 may depend upon a type of the emergency incident. For example, a first manner of activation may be employed when the emergency incident is associated with a movable subject 116 (shown in FIG. 1), such as the active shooter or the violent intruder. In accordance with various embodiments, the first manner of activation is obtained by simultaneous pressing of the first button 160 and the second button 162 of the input unit 172 of any device 122 for a predetermined time duration. The requirement for pressing both of the buttons 160 and 162 is to lessen the likelihood of the device 122 being accidently set off. In such an embodiment, the first button 160 serves as a fail safe. It will be appreciated that the manner of activation described in the present disclosure is purely exemplary and other manners of activation of the device 122 may be employed without limiting the scope of the present disclosure.

In accordance with various embodiments, when the input unit 172 of the device 122 is activated based on the first manner of activation, the non-audible alert provided to the other devices 122 corresponds to a first non-audible alert. For example, the first non-audible alert may correspond to vibration in the first predefined vibration pattern and/or illumination in the first predefined illumination color of the plurality of devices 122. Further, when the input unit 172 of the device 122 is activated based on the first manner of activation, the recipient is a law enforcement personnel.

A second manner of activation of the input unit 172 of the device 122 may be employed when the emergency incident corresponds to a medical emergency (vs. an active shooter or violent intruder). The second manner of activation is obtained by simultaneous pressing of the first button 160 and the third button 164 of the input unit 172 of any device 122 for the predetermined time duration. In accordance with various embodiments, when the input unit 172 of the device 122 is activated based on the second manner of activation, the control system 200 is configured to activate a second non-audible alert on the output unit 174 of the devices 122 according to the second manner of activation of the input unit 172. For example, the second non-audible alert may correspond to a vibration in the second predefined vibration pattern and/or an illumination in the second predefined illumination color of the plurality of devices 122.

In accordance with various embodiments, the control system 200 is configured to detect a device 122 of the plurality of devices 122 on which the input unit 172 is activated according to the second manner of activation. The control system 200, in response to the detection of such device 122, provide an additional emergency indicator 712 (such as shown in FIG. 8) along with its location data by altering at least one attribute of a marker 702 of the plurality of markers 702 corresponding to the device 122 on the virtual map 700. In accordance with various embodiments, the at least one attribute of the marker 702 during the first manner of activation of the input unit 172 is different from at least one attribute of the marker 702 during the second manner of activation of the input unit 172. For example, as shown in FIG. 8, at least one attribute of the marker 702 during the second manner of activation may correspond to adding a boundary to the marker 702. Additionally, the control system 200 is configured to place an additional audio call (for example, another one-way audio call) through the cellular network 212 to a communication device of at least one additional recipient, such as a medical personnel. In some instances, for example, when the device 122 is activated using both the first manner of activation and the second manner of activation, simultaneously or in sequence, only one audio call can be placed, for example, to 911 personnel to convey the detection of the movable subject 116 and the medical emergency.

The system and method of the present disclosure provide a solution for the widespread communication upon detection of an emergency incident in a facility 100. When a first device 122′ upon detection of the emergency incident is activated, the first device 122′ provides a non-audible alert to other devices 122 in the facility to communicate the detection of the emergency incident. Moreover, the emergency indication 708 is displayed on the display device 124 positioned for example, in the administrative room or a principal's room to communicate and track real time whereabouts of the movable subject associated with the emergency incident. Additionally, the one-way audio call to law enforcement personnel is established to provide the audible outputs associated with the emergency incident. This may enable the staff members 118 and the law enforcement personnel to take immediate actions based on the real time information. Moreover, the requirement for simultaneous pressing of the buttons 160 and 162 for the predetermined time duration to activate the device 122 prevents any accidental activation of the device 122.

Furthermore, the non-audible alert corresponding to the illumination and/or vibration of the devices 122 also allows students of the facility 100 to be alerted in addition to the staff members 118, thereby facilitating the widespread communication. Moreover, the non-audible alert, unlike the use of loud sirens and alarms, notifies the individuals in the facility 100 of the emergency incident without traumatizing the students or creating any panic situation in the facility 100.

The one-way audio call also assists in communicating vital information associated with the emergency incidents with the law enforcement personnel even before any law enforcement personnel visits the facility 100. Also, use of a one-way audio call for transmission of the audible outputs from the staff member 118 to the law enforcement personnel enables the staff member 118 to speak whenever they are comfortable without worrying about being overheard having two-way communication with the law enforcement personnel.

Additionally, the system and method of the present disclosure also provides a solution to communicate medical emergencies, such as injuries, in the facility 100 to the medical personnel and the display device 124.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for responding to an emergency incident in a facility, the system comprising:
a display device with a virtual map of the facility; and
a plurality of devices configured to be respectively worn by a plurality of users in the facility, wherein each device of the plurality of devices is configured to be activated upon detection of the emergency incident in the facility,
wherein, when activated, each device of the plurality of devices is configured to:
provide a non-audible alert to other devices of the plurality of devices,
provide an emergency indication along with its location data for display on the virtual map, and
place a one-way audio call through a cellular network to at least one recipient.

2. The system of claim 1, further comprising:
a control system in communication with the plurality of devices, wherein the control system is configured to: when a second device of the plurality of devices is activated in sequence to a first device of the plurality of devices, placing an additional one-way audio call between the second device and at least one additional recipient through the cellular network.

3. The system of claim 2, wherein the control system is configured to:
indicate, on the display device, locations of the plurality of devices respectively through a plurality of markers on the virtual map of the facility; and
alter at least one attribute of markers of the plurality of markers corresponding to the first device and the second device, when the first device and the second device are activated.

4. The system of claim 3, wherein altering the at least one attribute of markers corresponds to altering color of the corresponding markers on the virtual map.

5. The system of claim 3, wherein the control system is configured to:
create a path on the virtual map based on a sequence of alteration of the at least one attribute of the markers corresponding to the first device and the second device.

6. The system of claim 2, wherein the control system is configured to:
determine a distance between the first device and the second device; and
place the additional one-way audio call when the distance between the first device and the second device is greater than a threshold value.

7. The system of claim 1, wherein the non-audible alert is a first non-audible alert provided according to a first manner of activation of each device and the at least one recipient is a law enforcement personnel, and further wherein each device is configured to:
provide an alert to other devices of the plurality of devices according to a second manner of activation;
provide an additional emergency indication along with its location data for display on the virtual map, and
place an audio call through the cellular network to at least one additional recipient, wherein the at least one additional recipient is a medical personnel.

8. The system of claim 7, wherein at least one attribute of the emergency indication is different from at least one attribute of the additional emergency indication.

9. A system for communicating and tracking real-time whereabouts of a movable subject in a facility, the system comprising:
a plurality of devices configured to be respectively worn by a plurality of users in the facility, each device of the plurality of devices including:
a microphone;
an input unit and an output unit; and
a transceiver selectively configured to:
transmit an instruction to other devices of the plurality of devices upon an activation of the input unit; and
receive the instruction from any of the other devices upon an activation of the input unit on any of the other devices; and
a control system, in response to a transmission of the instruction by the transceiver associated with any device of the plurality of devices or a receipt of the instruction by the transceiver associated with any device of the plurality of devices, configured to:
activate a non-audible alert on the output unit;
detect a last device of the plurality of devices on which the input unit is last activated or from which the instruction is last transmitted;
alter at least one attribute of a marker of a plurality of markers corresponding to the last device on a virtual map of the facility; and
place a call through a cellular network to at least one recipient, such that when the call is established, an audible output inputted into the microphone associated with the last device, is received by the at least one recipient.

10. The system of claim 9, wherein the control system is further configured to:
create a path to determine the real-time whereabouts of the movable subject in the facility based on a sequence of alteration of the at least one attribute of the plurality of markers on the virtual map.

11. The system of claim 9, wherein the non-audible alert is a first non-audible alert provided according to a first manner of activation of the input unit and the at least one recipient is a law enforcement personnel, and further wherein the control system is configured to:
activate a second non-audible alert on the output unit according to a second manner of activation of the input unit;
detect a device of the plurality of devices on which the input unit is activated according to the second manner of activation;
alter at least one attribute of a marker of the plurality of markers corresponding to the device on the virtual map; and
place an additional call through the cellular network to at least one additional recipient, wherein the at least one additional recipient is a medical personnel.

12. The system of claim 11, wherein at least one attribute of a marker during the first manner of activation of the input unit is different from at least one attribute of the marker during the second manner of activation of the input unit.

13. A method for responding to an emergency incident in a facility, the method comprising:
activating a device of a plurality of devices upon detection of the emergency incident in the facility, the plurality of devices being configured to be respectively worn by a plurality of users in the facility;
providing, by the device, a non-audible alert to other devices of the plurality of devices;
providing, by the device, an emergency indication along with its location data for display on a virtual map of the facility displayed on a display device; and
placing, by the device, a one-way audio call through a cellular network to at least one recipient.

14. The method of claim 13, further comprising:
when a second device of the plurality of devices is activated in sequence to a first device of the plurality of devices, by placing an additional one-way audio call between the second device with at least one additional recipient through the cellular network.

15. The method of claim 14, further comprising:
indicating, by the control system, locations of the plurality of devices respectively through a plurality of markers on the virtual map of the facility on the display device; and
altering, by the control system, at least one attribute of markers of the plurality of markers corresponding to the first device and the second device, when the first device and second device are activated.

16. The method of claim 15, wherein altering the at least one attribute of markers corresponds to altering color of the corresponding markers on the virtual map.

17. The method of claim 15, further comprising:
creating, by the control system, a path on the virtual map based on a sequence of alteration of the at least one attribute of the markers corresponding to the first device and the second device.

18. The method of claim 14, further comprising:
determining, by the control system, a distance between the first device and the second device; and
placing, by the control system, the additional one-way audio call when the distance between the first device and the second device is greater than a threshold value.

19. The method of claim 13, wherein the non-audible alert is a first non-audible alert provided according to a first manner of activation of the device and the at least one recipient is a law enforcement personnel, and further wherein the method comprises:
providing, by the device, an alert to the other devices according to a second manner of activation;
providing, by the device, an additional emergency indication along with its location data for display on the virtual map, and
placing, by the device, an audio call through the cellular network to at least one additional recipient, wherein the at least one additional recipient is a medical personnel.

20. The method of claim 19, wherein at least one attribute of the emergency indication is different from at least one attribute of the additional emergency indication.
